(19) United States
(12) Patent Application Publication
(10) Pub. No.: US 2017/0138762 A1
(43) Pub. Date: May 18, 2017

(54) Door-window sensor

(71) Applicant: Beijing Eco-smart Automation & Control Technology Co.,Ltd., Beijing (CN)

(72) Inventor: XIAOWEI JIANG, Beijing (CN)

(21) Appl. No.: 15/087,638

(22) Filed: Mar. 31, 2016

(30) Foreign Application Priority Data
Nov. 13, 2015 (CN) 201520906696.4

(51) Int. Cl. G01D 5/14; E06B 1/04; G01D 5/20

(52) U.S. Cl. CPC G01D 5/145; G01D 5/20; E06B 1/04; E05F 15/00

(57) ABSTRACT

This invention discloses a door-window sensor which can be integrated with the associated fittings of the door and window. The sensor cannot be seen from appearance of the door and window, thus making the door and window beautiful and elegant on the whole. It can be installed easily without the limitation of door and window in the external dimension; it is used to determine whether the door and window is locked or closed; its cost is at a lower level. For the sensor, the door and window consists of frame and leaf. The leaf is driven by the motor to rotate around the connected axis and locked to the frame by means of lock. It gets close to inner side of the frame when closed and away from inner side of the frame when opened. The sensor consists of induction generating components, inductive device and data processing unit. One of the induction generating component and inductive device is arranged on the outside of leaf corresponding to the lock and the other is arranged inside the frame corresponding to the lock hole. The data processing unit is arranged outside or inside the door and window. State change of the inductive device is sent to the data processing unit by wired and/or wireless means.

### TECHNICAL FIELD

The utility model belongs to the technical field of intelligent doors and windows and especially relates to a door-window sensor which can be integrated with the door and window.

### BACKGROUND TECHNOLOGY

With social development and technological progress, people increasingly require the improvement of life quality and intelligent home gradually enters people's life. Intelligent door and window is an important part of intelligent home and have increasing attentions paid by producers and customers.

An important function of the intelligent door and window is to determine the state of door and window, which gradually receives great interests from R&D personnel. The existing devices of door and window state mainly include window magnet and door magnet products. The principle is to utilize mutual attraction between the reed switch/Hall sensor and magnet. When the magnet gets close to or far away the associated sensor, the reed switch or Hall sensor will automatically turn off or turn on the circuit to generate association signals, thus determining the state of door and window.

The existing door and window magnet product consists of two parts, namely permanent magnet covered with plastics and sensor covered with plastics (reed switch or Hall sensor). A window or door needs to be equipped with a set of magnet product to determine the relative position change of window and door. The product is external, that is, it is installed outside the frame or leaf. But the deployment is inconvenient sometimes, because the product cannot be mounted or would cause an aesthetic impact for the reason of its boundary dimensions.

In addition, it is not reliable or comprehensive to determine relative position of the leaf and frame only by one set of such product. Therefore, the product cannot meet all requirements of functional doors and windows. If several sets of the products are arranged, the cost will rise and the aesthetic sense of the product appearance will be affected severely.

In addition, the existing door and window magnet product only can monitor an association relationship between the frame and the window (namely the rotational opening along the axis). It cannot determine the door-window locking device is locked or opened. Putting leaf and frame together may be unsafe or may be not locked.

### DESCRIPTION OF THE INVENTION

The utility model is designed to overcome the existing technical defects. It provides a door-window sensor which can be integrated with associated fittings of the door and window. The sensor cannot be seen from appearance of the door and window, thus making the door and window beautiful and elegant on the whole. It can be installed easily without limitation of door and window in the external dimension; it is used to determine whether the door and window is locked; its cost is at a lower level.

Technical solution for above-mentioned problem: for the sensor, the door and window consists of frame and leaf. The leaf is driven by the motor to rotate around the connected axis and locked to the frame by means of lock. It gets close to inner side of the frame when closed and away from inner side of the frame when opened. The sensor consists of induction generating component, inductive device and data processing unit. One of the induction generating component and inductive device is arranged on the outside of leaf corresponding to the lock and the other is arranged inside the frame corresponding to the lock hole. The data processing unit is arranged outside or inside the door and window. State change of the inductive device is sent to the data processing unit by wired and/or wireless means.

One of induction generating component and inductive device is arranged outside the leaf corresponding to the lock and the other is arranged inside the frame corresponding to the lock hole, so the sensor can be integrated with the associated parts of the door and window to make the door and window beautiful or elegant on the whole and installed easily without limitation of external dimensions of door and window; the lock would touch the lock hole when the inductive device is connected with the induction generating component, so the sensor can determine whether the door and window is locked; the sensor only needs to set up several induction generating components and inductive devices outside the leaf and inside the frame, so it has a lower cost than the existing technologies.

### FIGURES

FIG. 1 is the structure diagram for the first preferred embodiment of the window sensor.

FIG. 2 is the structure diagram for the second preferred embodiment of the window sensor.

FIG. 3 is the structure diagram for the third preferred embodiment of the window sensor.

FIG. 4 is the structure diagram for the fourth preferred embodiment of the window sensor.

FIG. 5 is the structure diagram for the first preferred embodiment of the door sensor.

### DESCRIPTION OF THE PREFERRED EMBODIMENTS

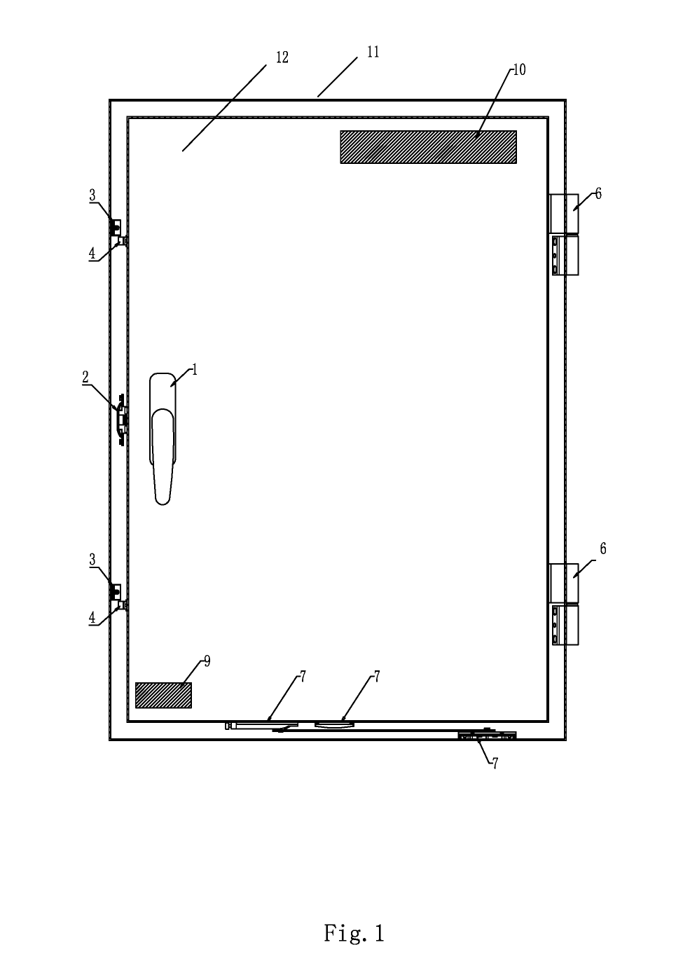

As shown in FIG. 1 to FIG. 5, for the door-window sensor, the door and window consists of frame (11) and leaf (12). The leaf is driven by the motor (10) to rotate around the connected axis and locked to the frame by means of lock (2) (in the position of handle 1). It gets close to inner side of the frame when closed and away from inner side of the frame when opened. The sensor consists of induction generating component (4), inductive device (3) and data processing unit. One of the induction generating component and inductive device is arranged on the outside of leaf corresponding to the lock and the other is arranged inside the frame corresponding to the lock hole. The data processing unit is arranged outside or inside the door and window. State change of the inductive device is sent to the data processing unit by wired and/or wireless means.

One of induction generating component and inductive device is arranged outside the leaf corresponding to the lock and the other is arranged inside the frame corresponding to the lock hole, so the sensor can be integrated with associated parts of the door and window to make the door and window beautiful or elegant on the whole and installed easily without limitation of external dimensions of door and window; the lock would touch the lock hole when the inductive device is connected with the induction generating component, so the sensor can determine whether the door and window is locked; the sensor only needs to set up several induction generating components and inductive devices outside the leaf and inside the frame, so it has a lower cost than the existing technologies.

In addition, the induction generating component and the inductive device are non-cylindrical and embedded into the leaf or frame. Their shapes include semi-cylinder, rectangular block, cube, etc. The non-cylindrical shape can maximize contact area between the inductive device and induction generating component to make the induction more sensitive and reliable. The induction generating component and the inductive device can be embedded into the leaf or frame to get integrated.

In addition, both induction generating component and the inductive device are connected to the frame or leaf by means of screws. Thus, they can be installed and dismantled easily at a lower cost. Of course, bonding, riveting, welding and other mounting types can be taken.

In addition, the inductive device is a reed switch or a Hall sensor and the induction generating component is a magnet, which is designed cleverly with a low cost and safety in use. The reed switch has a very small volume, which is easy to install and very applicable to the door-window sensor. Of course, other induction generating components and inductive devices can also be adopted. For example, the inductive device is a conductive profile seal mounted one or both sides of the frame and leaf to turn on the conductive profile seal by the extrusion arising from frame and leaf closing; the inductive device is a microswitch mounted on the frame or the leaf to act by extrusion arising from frame and leaf closing.

In addition, as shown from FIG. 1 to FIG. 5, the sensor also contains several groups of induction generating components and inductive devices. The induction generating components are arranged outside the leaf in mutual contact or inside the frame. The inductive devices are arranged on the other side of leaf or frame. Thus, induction results will be more accurate and reliable; intelligent doors and windows can perform more functions.

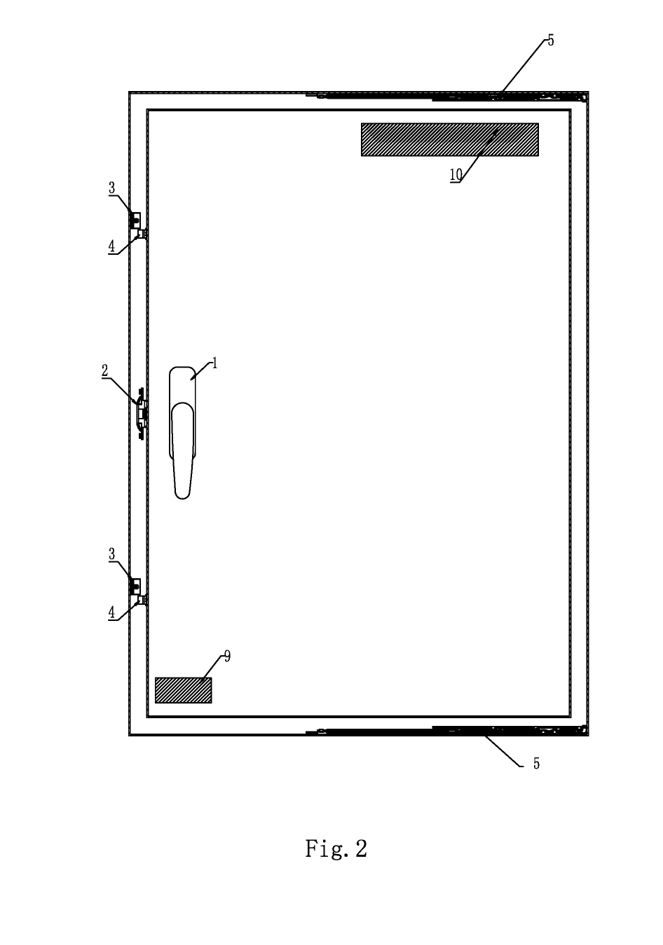

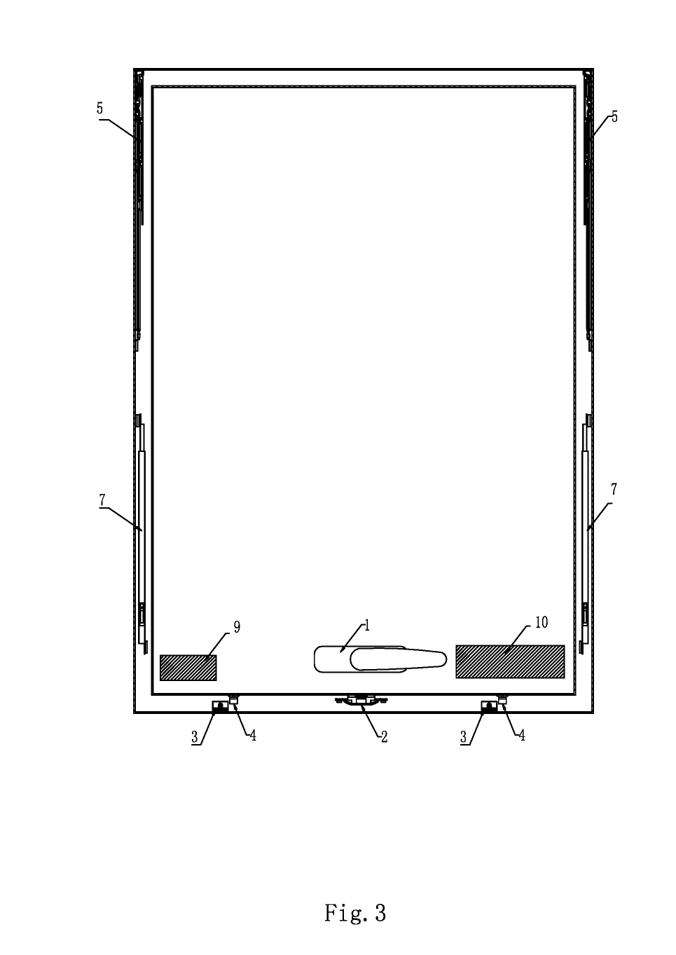

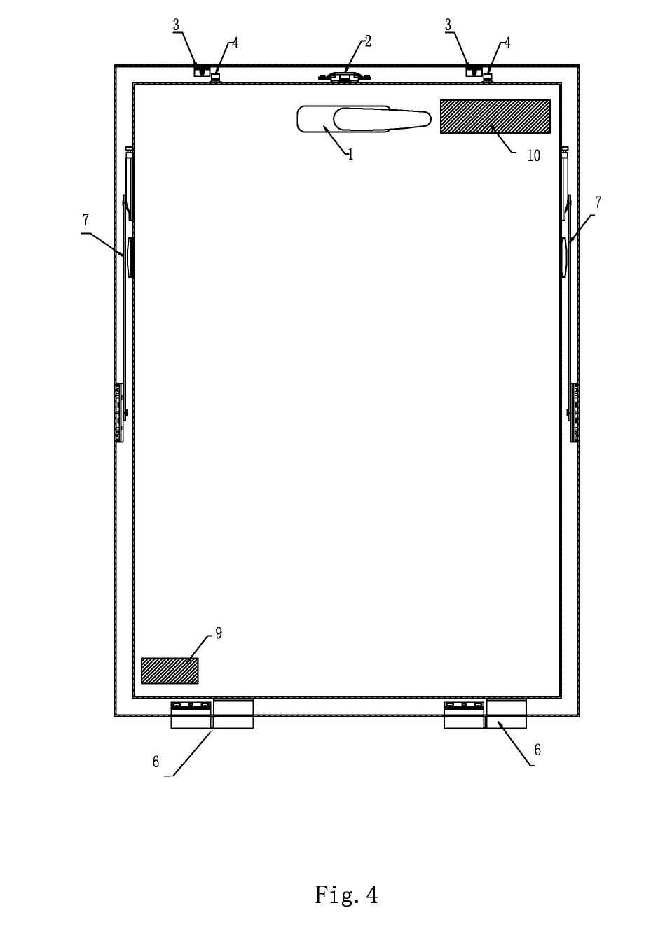

In addition, a group of induction generating components and inductive devices are respectively arranged on the switching side of the leaf and inside the corresponding frame, or a group of induction generating components and inductive devices are arranged in the position of hinge (5) or a group of induction generating components and inductive devices are arranged in the position of connecting rod (7). FIG. 1 shows a hinge type window. For the utility model, several groups of induction generating components and inductive devices are respectively arranged outside the leaf corresponding to the lock and inside the frame corresponding to the lock hole, on switching side of the leaf and inside corresponding frame, near the door hinge (6) and in the position of connecting rod (7). FIG. 2 shows a hinged window. For the utility model, several groups of induction generating components and inductive devices are respectively arranged outside the leaf corresponding to the lock and inside the frame corresponding to the lock hole, on switching side of the leaf and inside corresponding frame and in the position of hinge (5). FIG. 3 shows a top-hung window. For the utility model, several groups of induction generating components and inductive devices are respectively arranged outside the leaf corresponding to the lock and inside the frame corresponding to the lock hole, on leaf switching side and inside corresponding frame and in the position of hinge (5) and connecting rod (7). FIG. 4 shows a reversely opened window. For the utility model, several groups of induction generating components and inductive devices are respectively arranged outside the leaf corresponding to the lock and inside the frame corresponding to the lock hole, on switching side of the leaf and inside corresponding frame and in the position of hinge (5) and door hinge (6).

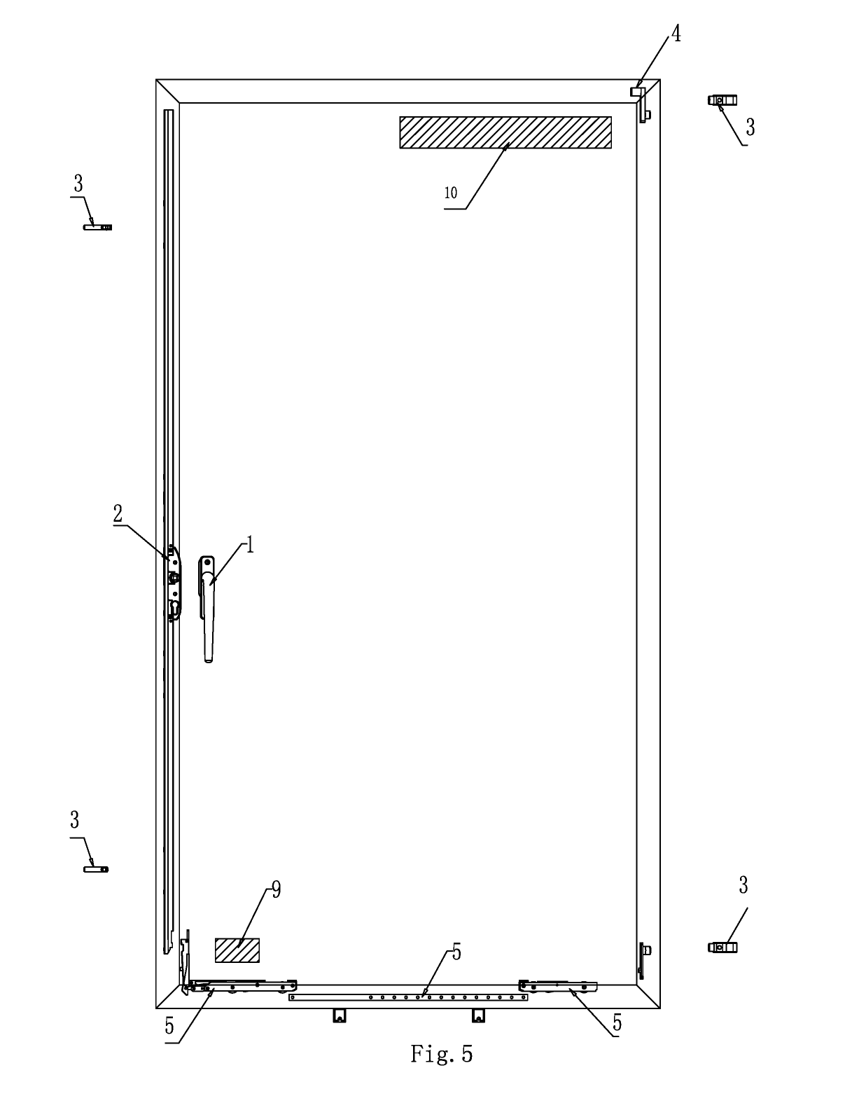

In addition, a group of induction generating components and inductive devices also can be set up respectively at the upper and lower end of switching side of the leaf and inside the corresponding frame. Thus, door/window state data can be obtained more accurately. FIG. 5 shows a lift-and-slide door. For the utility model, several groups of induction generating components and inductive devices are respectively arranged outside the leaf corresponding to the lock and inside the frame corresponding to the lock hole, on the leaf switching side and inside corresponding frame, on the leaf connecting side and inside the corresponding frame, at the upper and lower end of leaf switching side and inside the corresponding frame, and in the position of hinge. Of course, more induction generating components and inductive devices could be adopted to make the data more accurate in consideration of costs.

In addition, the data processing unit is a microprocessor which can obtain the leaf opening angle by the algorithm based on the distance between induction generating components and inductive devices, that between the lock and leaf connecting side and that between the lock hole and leaf connecting side. It can also obtain the ventilation quantity data based on the opening angle and air speed.

In addition, the sensor also contains an audible and visual alarm module connected to the data processing unit. It can determine abnormal operation towards the frame and window and give an alarm when the data processing unit receives a message of the door leaf leaving the door frame or the window leaf leaving the window frame and that of the door and window in the locking state. The audible and visual alarm module also can be set up on the door and window or be away from the door and window.

In addition, the sensor also contains a Bluetooth module (9) on the leaf. The Bluetooth module is connected with the inductive devices to communicate with the data processing unit. Thus, the cost for utilization of communication cables could be reduced; the Bluetooth communication is more reliable and has a lower cost than other wireless communication modes.

Compared with the existing technologies, the utility model has the following beneficial effects:

1. It can effectively determine the relative state of leaf and frame and the state of door/window locking device.

2. It can be deployed in multiple positions without damage to the appearance of doors and windows.

3. The sensor is integrated with functional components of doors and windows.

4. It can upgrade security function of doors and windows and be used for fine control of door/window opening.

5. It can make opening accessories indispensable for doors and windows performing an intelligent perceptive function.

What is said above is the preferred embodiment of the utility model rather than limitation of the utility model in any form. Ordinary technical personnel in this field shall understand that, all simple modifications and equivalent changes made under the idea and principle of the utility model are included in the protection scope of the utility model technical scheme.

1. A door-window sensor, comprising: a frame (11) and a leaf (12), wherein the leaf is driven by the motor (10) to rotate around the connected axis and locked to the frame by means of lock (2), it gets close to inner side of the frame when closed and away from inner side of the frame when opened, and it is characterized in that: the sensor consists of induction generating component (4), inductive device (3) and data processing unit, one of the induction generating component and inductive device is arranged on the outside of leaf corresponding to the lock and the other is arranged inside the frame corresponding to the lock hole, and the data processing unit is arranged outside or inside the door and window, and state change of the inductive device is sent to the data processing unit by wired and/or wireless means.

2. The door-window sensor according to claim 1, the door-window sensor is characterized in that the induction generating component and the inductive device are non-cylindrical and embedded into the leaf or frame.

3. The door-window sensor according to claim 2, the door-window sensor is characterized in that the induction generating component and the inductive device are connected to the frame or leaf with screws.

4. The door-window sensor according to claim 3, the door-window sensor is characterized in that the inductive device is a reed switch or Hall sensor and the inductive generating component is a magnet; or the inductive device is a conductive profile seal installed on one side or both sides of the frame or leaf and the conductive profile seal turns on by means of extrusion caused by frame or leaf closing; or the inductive device is a microswitch installed on the frame or the leaf, which acts under the extrusion caused by closing of frame or leaf.

5. The door-window sensor according to claim 4, the door-window sensor is characterized in that: the sensor consists of induction generating components and inductive devices in groups, the induction generating components are arranged outside the leaf in mutual contact or inside the frame, and the inductive devices are arranged on the other side of leaf or frame.

6. The door-window sensor according to claim 5, the door-window sensor is characterized in that: a group of induction generating components and inductive devices are respectively arranged on the leaf switching side and inside the corresponding frame, a group of induction generating components and inductive devices are arranged in the position of hinge (5) or a group of induction generating components and inductive devices are arranged in the position of connecting rod (7).

7. The door-window sensor according to claim 6, the door-window sensor is characterized in that: a group of induction generating components and inductive devices are respectively set up at the upper and lower end of leaf switching side and inside the corresponding frame.

8. The door-window sensor according to claim 1, the door-window sensor is characterized in that: the data processing unit is a microprocessor which can obtain leaf opening angle by the algorithm based on the distance between induction generating components and inductive devices, that between the lock and leaf connecting side and that between the lock hole and leaf connecting side.

9. The door-window sensor according to claim 1, the door-window sensor is characterized in that: the sensor also contains an audible and visual alarm module connected to the data processing unit, it can give an alarm when the data processing unit receives a message of the door leaf leaving the door frame or the window leaf leaving the window frame and that of the door and window in the locking state.

10. The door-window sensor according to claim 1, the door-window sensor is characterized in that: the sensor also contains a Bluetooth module on the leaf, and the Bluetooth module is connected with inductive devices to communicate with the data processing unit.
